(19) United States
(12) Patent Application Publication
(10) Pub. No.: US 2010/0127509 A1
(43) Pub. Date: May 27, 2010

(54) Gravity Engine

(76) Inventor: Mike McCarthy, Drive Bend, OR (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/624,326

(22) Filed: Nov. 23, 2009

Related U.S. Application Data
(60) Provisional application No. 61/117,075, filed on Nov. 21, 2008.

(51) Int. Cl. H02K 7/18; F03B 17/04

(52) U.S. Cl. 290/1 R; 74/DIG. 9

(57) ABSTRACT

An energy capturing apparatus for capturing energy from gravity and buoyancy acting on a plurality of spheres circulating through the system. In a first phase gravity acts to accelerate the spheres on a conveyor belt imparting rotational force to the belt which may be harnessed to perform work. Concurrently, buoyancy of a fluid filled conduit provides a manner to return the spheres to the top of the conveyor to continue to rotate it and provide the energy to the conveyor belt to perform work. Axles at both ends of the conveyor belt may be engaged mechanically to communicate the force of the spheres being attracted by gravity to turn the belt.

This application claims priority from U.S. Provisional Application No. 61/117,075 filed on Nov. 21, 2008 and incorporated herein in its entirety by reference.

### BACKGROUND OF THE INVENTION

1. Field of the Invention

The invention herein disclosed relates generally to energy generation. More particularly it relates to a combination gravity and buoyancy engine, providing energy for work purposes, through the concurrent employment of both gravitational force on a plurality of spheres having mass, and energy developed from a repositioning of those spheres through the employment of gravity and buoyancy.

2. Prior Art

### BACKGROUND OF THE INVENTION

Industrialized countries throughout the world in the 20^{th} and 21^{st} centuries have an ever increasing requirement for energy proportional to their populations and production of products for national and international consumption. Conventionally, water power such as dams, or burning of fossil fuels such as oil and gas, have provided the modern world with their main source of energy for industry and for every more energy dependent populations.

With the increase in the world's population and the industrial output of new industrialized nations such as China, combined with ever decreasing natural energy resources, there is an increasing need to find alternate energy sources. Because of the modern theory of global warming being caused from burning fossil fuels, and the problems with pollution that oil causes in the world's environment, it is preferable if new energy sources are non-polluting and that they do not produce carbon dioxide.

As a result, greater emphasis is increasingly being placed on creating mechanical devices which either operate more efficiently, or which produce energy, in an attempt to conserve current resources. However, it is currently being recognized that many alternative energy sources exist, such as wind power, which are being under utilized. Further, many potential non-polluting, renewable natural energy resources, such as gravity and solar energy, are currently under-exploited.

As such, there is an unmet need for a widely deployable and inexpensive new energy capturing device and method. Such a method should be employable using a device which captures natural energy forces like water power, rather than burning fossil fuels to generate energy. Still further, such a method and device should be adaptable for use in a wide variety of venues and energy requirement situations using conventional means to connect the generated power to devices requiring it.

### SUMMARY OF THE INVENTION

The energy capturing apparatus and method herein described and disclosed, combines and harnesses power from gravity acting on a plurality of spheres having mass, in combination with the power harnessed from the force on the spheres from buoyancy during the return of those spheres to an elevated position. Employing this capture of energy and power from this combination of two forces, mechanical energy can be harnessed. The mechanical energy so captured, using conventional means for communication of mechanical power, may be employed to directly power mechanical devices requiring power for work such as the production of electrical power on the grid which may be transmitted great distances or just to power machinery locally.

The method employing the system herein, or those similar systems as would occur to those skilled in the art, harnesses the gravitational force acting on the mass of a plurality of spheres engageable to a substantially vertically disposed conveyor system. Using this gravitational force acting on the mass of the individual spheres engaged to the conveyer system, power is thereby harnessed and communicated mechanically to rotate wheels engaged to a conveyor belt which has positions thereon for temporary engagement to the plurality of balls. The conveyer-connected wheels or gears act to directly communicate power from the forces of the mass of the plurality of balls to machinery requiring power to operate. Using conventional means to communicate the power generated from this gravitational attraction of the spheres or balls, energy may be thereby communicated locally to machinery such as a mill to produce wood products. Alternatively, the power harnessed may be communicated mechanically in a conventional fashion to a means for electrical energy generation such as a generator to provide electricity which may be transmitted using conventional means to a remote location.

In operation of the device and method, the plurality of spheres are consecutively deposited upon shelves engaged to the conveyor belt. The belt is operatively engaged to a rotational system in a conventional fashion such as using a chain or notched belt engaged to geared wheels operatively engaged to the chain or belt. The force of gravity attracting the mass of each of the spheres consecutively deposited upon the belt accelerates the belt in its rotational engagement to the gears or wheels. This generally circular rotation of the belt or chain, caused by the forces acting on the mass of each sphere, imparts the force or torque to the engaged wheels causing a rotation. Conventional mechanical engagement to the rotating wheels or gears will thus provide power to whatever device is engaged thereto.

A novel component of the device and system herein is the manner of return of the spheres, from their disengagement at a lowest point on the belt or conveyor, to an elevated position such that they may be re-engaged upon the conveyor belt. Employing the method herein, at a bottom position during the rotation of the belt of the conveyor each sphere is operatively dismounted from the belt and deposited upon a ramp. The ramp adjacent to the dismount position of the spheres is adapted with means for sealing from fluid pressure and operates to place the spheres into a solution having a relative density or specific gravity which on a volume basis is higher than that of the volume of each sphere. So deposited in the fluid, and with the spheres having a relative density lower than that of the area of fluid so occupied, the spheres will thus rise in the solution due to their buoyancy. The relative force generated by rising spheres may be adjusted by changing the relative density of the fluid or that of the material forming the spheres or by combinations of both. For instance the sphere may be made of plastic or the fluid changed from water to alcohol. Alternatively, the spheres may be filled with a gas such that they are inherently buoyant when placed within a fluid such as water.

Once spheres have reached the bottom of the shaft occupied by the conveyor system, they are communicated to a position where they are submerged within the bottom of the elongated substantially vertical liquid filled cylinder. Having a relative density less than that of the fluid for the area they occupy therein, the spheres will naturally rise to a position for deposit back onto the conveyer system where the process starts over. The longer the vertical rise of the fluid cylinder, and the length of the conveyer shaft, the more spheres may be employed concurrently. An increase in the number of spheres communicating force to the conveyer will cause a resulting increase in the energy generating power in the conveyor since the mass of the spheres multiplies the force on the conveyor in a manner proportional to their number and the height of the drop to the bottom of the cylinder. Additionally, since the force of the spheres being acted upon by gravity is multiplied by the number and mass of the spheres themselves and the wheels or gears rotating in concert with the belt are on a set number of axles, friction loss is minimized as the number of spheres increases.

Particularly preferred in the disclosed device and method is the means for urging the spheres from the vertical fluid filled conduit and back onto the conveyer. Employing the plurality of spheres herein disposed in the fluid, each sphere communicated to the bottom of the fluid filled conduit will rise vertically at a force upwards toward the surface. The rising force the higher density fluid exerts on each submerged sphere will provide an upward force on the spheres according to the Archimedes principle. This principle provides that the magnitude of the upward force exerted onto the spheres is equal to that of the mass of the volume of the fluid which is displaced minus the mass of the volume of the material forming the spheres. Consequently, once engaged within the fluid chamber at the bottom of the belt, the spheres will naturally rise to the surface. Upon reaching the top of the fluid surface, the leading sphere will be consecutively urged by the upward force of the rearward trailing spheres acting on it. The combined force of the trailing spheres reaching the surface of the fluid provides a means to push preceding spheres over the top of the curved edge of the fluid filled conduit, where it rolls to a re-engagement on the conveyer belt.

With respect to the above description, before explaining at least one preferred embodiment of the invention in detail, it is to be understood that the invention is not limited in its application to the details of construction and to the arrangement of the components or steps of the method set forth in the following description or illustrations in the drawings. The various apparatus and methods of employment of the invention are capable of other embodiments and of being practiced and carried out in various ways which will be obvious to those skilled in the art once they are educated in the art herein upon review this disclosure. Also, it is to be understood that the phraseology and terminology employed herein are for the purpose of description and should not be regarded as limiting.

Therefore, those skilled in the art will appreciate that the conception upon which this disclosure is based, may readily be utilized as a basis for designing of other devices, methods and systems for carrying out the several purposes of the present gravity engine. It is important, therefore, that the objects and claims be regarded as including such equivalent construction and methodology insofar as they do not depart from the spirit and scope of the present invention.

Further objectives of this invention will be brought out in the following part of the specification wherein detailed description is for the purpose of fully disclosing the invention without placing limitations thereon.

### BRIEF DESCRIPTION OF DRAWING FIGURES

FIG. 1 is a side view of a depiction of the operating principles of the device and method herein.

FIG. 2 is a top view, close up, depicting a means for sealed engagement of the bottom of the shaft housing the conveyor with the fluid cylinder.

FIG. 3 is a top view of the fluid cylinder showing a frusto-conical shaped top housing leading to an exit conduit for the spheres.

FIG. 4 depicts the engagement of the spheres from the top of the fluid cylinder to the conveyor belt.

FIG. 5 depicts another mode providing the reinsertion of the spheres to the conveyer using a worm gear at the lower end of the fluid filled conduit which creates a current in the lower end of the conduit to increase the rate of sphere rise.

### DETAILED DESCRIPTION OF THE PREFERRED EMBODIMENTS OF THE INVENTION

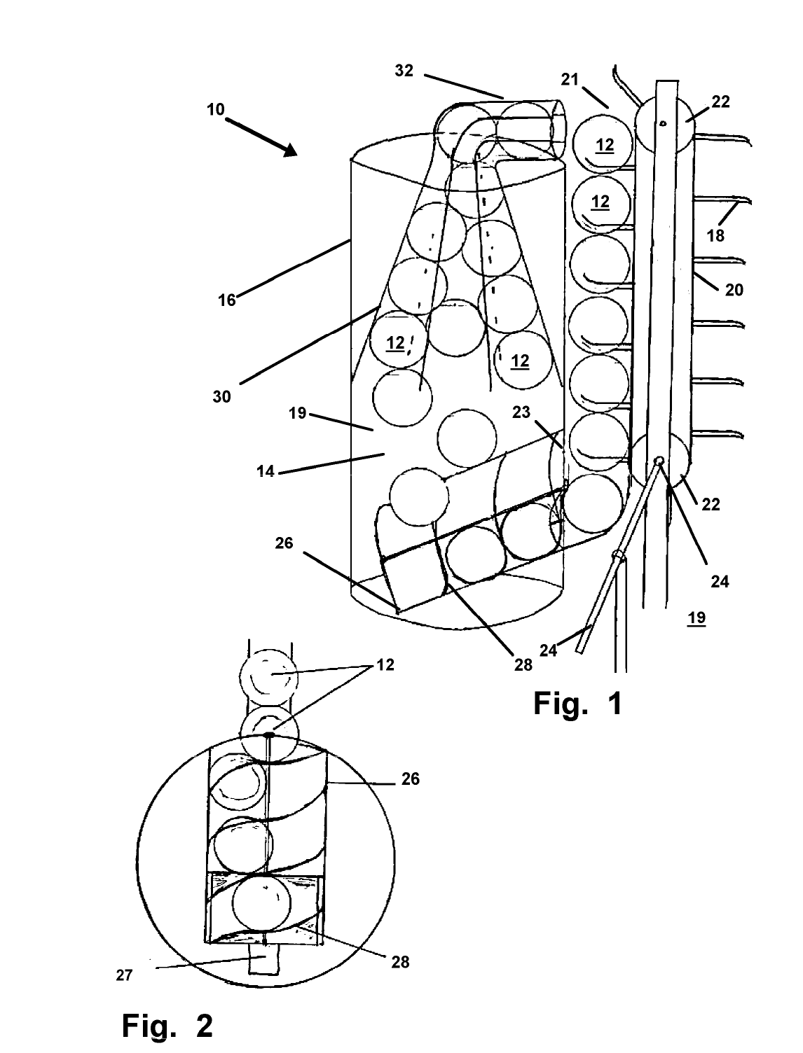

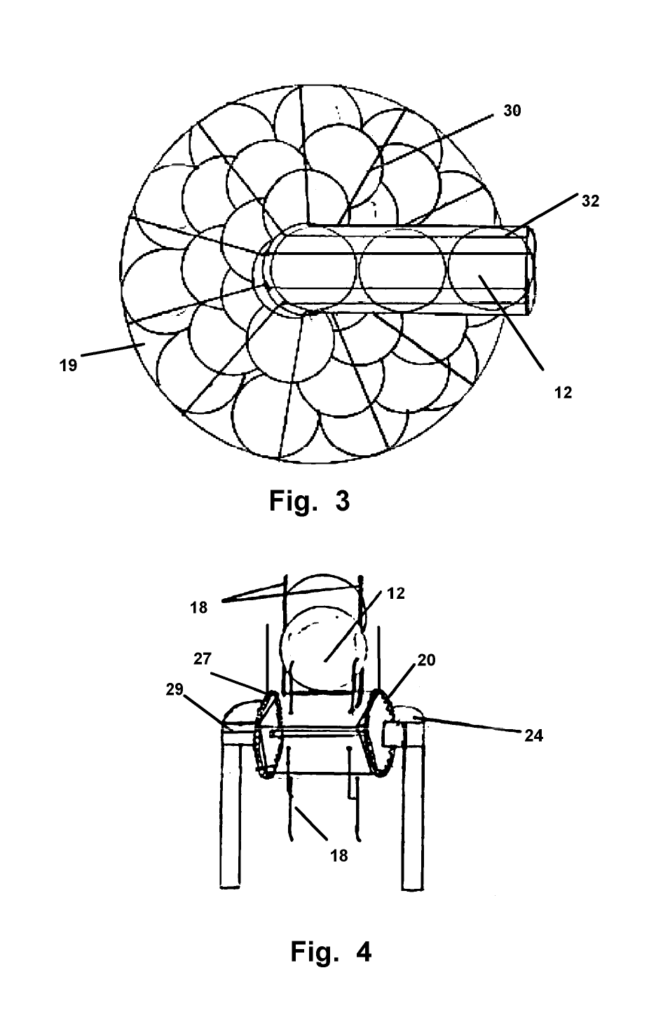

Referring now to the drawings in FIGS. 1-5 wherein similar parts are identified by like reference numerals, there is seen in FIG. 1, the top view of the preferred device 10 adapted to provide power pursuant to the method herein for providing mechanical power through capture of using both gravity and buoyancy in combination.

The device 10, employs a plurality of spheres 12 in system wherein gravity acting on the mass of each sphere 12 is communicated as power to operate a conveyer 20 as the spheres 12 descend. Concurrently, buoyancy provides the power to raise the descended spheres 12 to an elevated level where the operation is repeated. This concurrent employment of the forces of gravity acting on the spheres 12 during a descending state and buoyancy acting to raise the spheres 12 provides a novel manner to harness the energy of gravity acting on the spheres 12 to provide power to rotate the conveyer which is engaged to communicate the harnessed power to operate machinery.

Each of the spheres 12 is sized for removable engagement upon a conveyor 20 adapted to receive it using shelves 22 adapted to support the spheres 12 during decent. Means to dismount the spheres 12 is provided by a tilting of the shelves 22 as they approach and traverse over the wheel 22 at the lower end of the conveyor 20. Each sphere 12 is also formed in a fashion which imparts sufficient buoyancy to the sphere 12 such that when it is submerged in a fluid 14 held within an elongated conduit 19, the sphere 12 will rise with a force. The system adapted for employment with the device 10 herein, or those that would reasonably occur to those skilled in the art, thus concurrently employs the forces of both gravity and buoyancy concurrently to generate power to do work.

In operation, a plurality of spheres 12 are sized to be operatively removably engaged upon shelves 18 which are each operatively engaged upon a conveyor 20. The conveyor 20 is rotationally engaged around a pair of wheels 22, or gears or the like, such that a rotation of the conveyor 20 from the force of gravity acting on the spheres 12 will cause a rotation of the engaged wheels 22.

Gravitational force on each of the plurality of spheres 12 removably supported on the shelves 18 of the conveyor 20, imparts a downward force on one side of the belt 27 of the conveyor 20 to rotate operatively engaged wheels 22 which are engaged to the conveyor belt 27. The conveyor 20 may employ a belt 27 which may be a chain, notched belt, or similar flexible rotational member adapted to engage with the wheels 20 at both ends.

At a position adjacent to the lowest point of the conveyor 20, the wheels 22 engaged to the belt 27 are mechanically engaged to an axle 24, or by using internal shafts 29 engaged to the axle 24, or other means for mechanical engagement such that their rotational force of the wheels 22 from the conveyor 20 may be communicated to a device requiring power to do work such as a generator or directly to machinery.

The conveyer 20 may be housed to operate within a shaft 21 or other manner to allow descending of the spheres 12 thereon. At a lower point in the rotation of the conveyor 20 or in the shaft 21, the spheres 12 are consecutively dismounted from the shelves 18 or other means for engagement to the conveyor 20, and are deposited in a manner to traverse upon a descending ramp 26 leading to an entryway 23 at the lower end of a fluid filled conduit 19. Means for sealing at the entryway 23 to the conduit 19 is provided to prevent fluid 14 from entering the shaft 21 under the fluid pressure at the bottom of the substantially vertically disposed fluid-filled conduit 19. Such a means for sealing fluid 14 from the shaft 21 may be a worm gear 28 in rotational sealed engagement with the ramp 26, or by maintaining air pressure in the shaft 21 at a level substantially equal to the fluid pressure where the shaft 21 communicates with the fluid 14 in the bottom of the fluid filled conduit 19, or by other means for prevention of fluid 14 rising into the shaft 21 as would occur to those skilled in the art. The worm gear 28 may be engaged to a small motor 27 to aid in its rotation, or should the gravitational force of the spheres 12 acting on the worm gear 28 be sufficient to rotate the worm gear 28, then the motor 27 can double as a generator.

The spheres 12, once communicated to the fluid 14 in the conduit 19, are sufficiently buoyant therein to rise in the fluid 14 due to their having a relative density or specific gravity adapted to cause such a rise. So deposited in the fluid 14, and with the spheres having a relative density lower than that of the area of fluid 14 so occupied, the spheres 12 will thus rise in the fluid 14 due to the force of their buoyancy therein.

The force and speed of the rise of the spheres 12 in the fluid 14 may be adjusted by changing the solution forming the fluid 14 or changing the material forming the spheres 12 to those which have higher or lower specific gravity factors relative to the other. As noted, the spheres 12 might also be filled with a gas such that they are inherently buoyant when placed within a fluid 14 such as water.

As can be seen in FIG. 1, once the spheres 12 rise to the surface of the fluid 14, they reach a funnel shaped termination point adjacent to the top of the conduit 19 depicted as cover 30. This frusto conical shape at the upper termination point of the conduit 19, herds the spheres 12 in a manner causing them to enter the return conduit 32 which is at the narrow end of the funnel shaped termination point. This focusing or herding of the leading spheres 12 will cause the trailing spheres 12 to combine buoyancy forces and provide a means to push preceding spheres 12 over the top of the fluid filled conduit 19 along the return conduit 32 and to a re-engagement on the conveyor 20 to repeat the process.

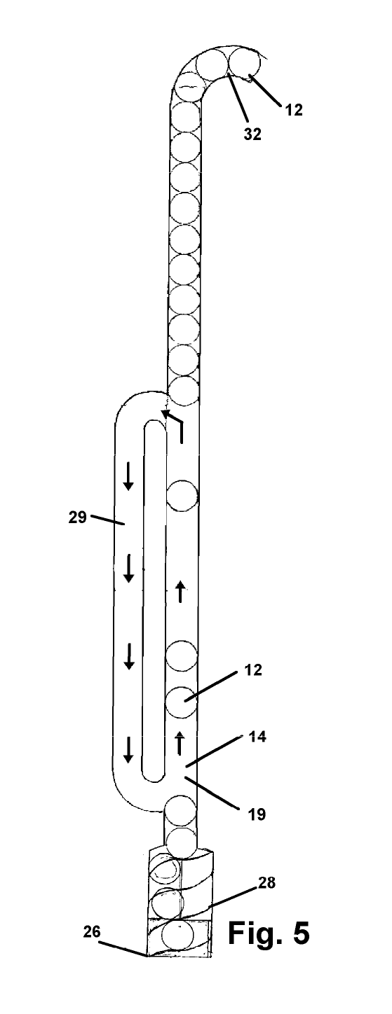

Finally, an alternative mode of communication of the spheres 12 to the conduit 19 is shown in FIG. 5. In this mode reinsertion of the spheres 12 to the conveyer 20 is accomplished by placement of the worm gear 28 of FIG. 2, at the lower end of the fluid filled conduit 19 and having a loop 29 in the conduit 19 to create a current in the lower end of the conduit 19. This will increase the rate of spheres 12 rising through the conduit 19.

While all of the fundamental characteristics and features of the energy generation device employing gravity and buoyancy have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An energy generation device as shown in the drawings and described in the specification herein.

1. An energy capturing apparatus, comprising:
a gravity powered conveyor, said conveyor having means to temporarily engage with a plurality of spheres, each said sphere having an exterior surface shape configured to roll;
said conveyor having a rotating member engaged rotating around a rotational engagement at an upper end, and around a second rotational engagement around a lower end;
means to temporarily engage said spheres in a removable engagement to said conveyor;
means to dismount said spheres adjacent to said lower end and communicate said spheres to through an entryway;
said entryway providing a second pathway for said spheres into to a fluid filled conduit;
means to seal said entryway and prevent fluid from escaping therefrom during a communication of a said sphere therethrough;
said fluid filled conduit having an upper end communicating with a second pathway;
fluid in said fluid filled conduit having a specific gravity higher than said spheres;
said second pathway providing means to communicate spheres reaching said upper end of said conduit, to said means to temporarily engage said spheres to said removable engagement;
said spheres positioned in a temporary engagement with said conveyor undergoing an acceleration in a first direction toward said lower end at a first force, said first force being gravity attracting a mass of each of said spheres, thereafter said spheres communicated to said conduit through said entryway from said temporary engagement with said conveyor, being accelerated toward said upper end of said conduit by a buoyant force acting upon said spheres; and
whereby said rotational engagement to said conveyor at said upper or lower end engageable mechanically to communicate rotational power therefrom at substantially said first force, to perform work.

2. The energy capturing apparatus of claim 1, additionally comprising:
said upper end of said fluid filled conduit narrowing from a widest point in communication with said fluid filed conduit, to a narrower portion communicating with said second pathway;
said narrowest portion sized slightly larger than a diameter of a said sphere;
said widest portion being a multiple of said diameter;
whereby a said sphere leaving said upper end of said conduit to said pathway is pushed by a force provided by a plurality of said spheres following it into said narrower portion of said conduit.

3. The energy capturing apparatus of claim 1, additionally comprising:
said second pathway being a ramp inclining at an angle from a first position adjacent to said means to temporarily engage said spheres to said removable engagement to a second position adjacent said upper end of said conduit; and
said spheres deposited on said ramp at said second position rolling downward toward said first position.

4. The energy capturing apparatus of claim 2, additionally comprising:
said second pathway being a ramp inclining at an angle from a first position adjacent to said means to temporarily engage said spheres to said removable engagement to a second position adjacent said upper end of said conduit; and
said spheres deposited on said ramp at said second position rolling downward toward said first position.

5. The energy capturing apparatus of claim 1, wherein said means to seal said entryway and prevent fluid from escaping therefrom during a communication of a said sphere therethrough comprises:
a worm gear having a serpentine pathway therethrough; and said serpentine pathway providing a ramp for said spheres into said fluid filled conduit, and
a rotation of said worm gear providing means to prevent fluid from escaping through said entryway.

6. The energy capturing apparatus of claim 2, wherein said means to seal said entryway and prevent fluid from escaping therefrom during a communication of a said sphere therethrough comprises:
a worm gear having a serpentine pathway therethrough; and said serpentine pathway providing a ramp for said spheres into said fluid filled conduit, and
a rotation of said worm gear providing means to prevent fluid from escaping through said entryway.

7. The energy capturing apparatus of claim 3, wherein said means to seal said entryway and prevent fluid from escaping therefrom during a communication of a said sphere therethrough comprises:
a worm gear having a serpentine pathway therethrough; and said serpentine pathway providing a ramp for said spheres into said fluid filled conduit, and
a rotation of said worm gear providing means to prevent fluid from escaping through said entryway.

8. The energy capturing apparatus of claim 4, wherein said means to seal said entryway and prevent fluid from escaping therefrom during a communication of a said sphere therethrough comprises:
a worm gear having a serpentine pathway therethrough; and said serpentine pathway providing a ramp for said spheres into said fluid filled conduit, and
a rotation of said worm gear providing means to prevent fluid from escaping through said entryway.

9. The energy capturing apparatus of claim 1 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

10. The energy capturing apparatus of claim 2 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

11. The energy capturing apparatus of claim 3 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

12. The energy capturing apparatus of claim 4 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

13. The energy capturing apparatus of claim 5 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

14. The energy capturing apparatus of claim 6 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

15. The energy capturing apparatus of claim 7 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.

16. The energy capturing apparatus of claim 8 additionally comprising:
said conveyor formed of a flexible member;
said flexible member engaged with geared wheel at said rotational engagements at said upper and lower ends;
said means to temporarily engage said spheres in a removable engagement to said conveyor being a series of shelves engaged to said flexible member substantially equidistant from each other; and
said means to dismount said spheres adjacent to said lower end being a tilting of said shelves as they approach and traverse said lower end of said conveyor, whereby said spheres are dislodged from said shelves and deposited on a lower ramp leading to said entryway.
